(19) United States
(12) Patent Application Publication
(10) Pub. No.: US 2016/0288304 A1
(43) Pub. Date: Oct. 6, 2016

(54) Electronic Torque Wrench

(71) Applicant: Hsuan-Sen Shiao, Taichung City (TW)

(72) Inventor: Hsuan-Sen Shiao, Taichung City (TW)

(21) Appl. No.: 14/676,928

(22) Filed: Apr. 2, 2015

(51) Int. Cl. B25B 23/142

(52) U.S. Cl. CPC B25B 23/1422

(57) ABSTRACT

An electronic torque wrench includes a handle unit, a turning unit, a sensor unit, an operating unit, and a processor unit electrically connected to the sensor unit and the operating unit. The turning unit includes a wrench head member, first and second positioners, and a sleeve. The wrench head member has a head portion, a strain-measurement portion, and a shaft portion extending from the strain-measurement portion and rotatably received in the sleeve. The first and second positioners are connected to opposite ends of the shaft portion and exposed from the sleeve. The first positioner retains the wrench head member at a predetermined angular position relative to the sleeve and the handle unit.

### FIELD

The present disclosure relates to an electronic torque wrench, more particularly to an electronic torque wrench that is able to fix in position a rotatable wrench head.

### BACKGROUND

Referring to FIG. 1, a conventional torque wrench includes a handle unit 11 that is hollow and tubular and that is formed with an opening end 111, a wrench unit 12 that is connected to the handle unit 11 for wrenching a workpiece, a strain-measurement unit 13 that is received in the handle unit 11, and a grip 14 that is connected to an end of the handle unit 11. The handle unit 11 includes a positioning member 112 disposed in proximity to the opening end 111. The wrench unit 12 includes a wrench head 121, a neck member 123 that is formed with an annular groove 122, and a connecting member 124 that is connected to the neck member 123 and that is received in the handle unit 11. The neck member 123 is received in the tube unit 11 with the positioning member 112 being slidable in the annular groove 122 so that the wrench head 121 is rotatable relative to the handle unit 11. The strain-measurement unit 13 is connected to an end of the connecting member 124 opposite to the neck member 123 for measuring a deformation value of the wrench unit 12. The grip unit 14 includes a display member 141 that is electrically connected to the strain-measurement unit 13 for displaying a torque value calculated from the deformation value.

Although the wrench head 121 is capable of omniangle rotation to facilitate viewing of the display member 141, the unsteady wrench head 121 may cause forces applied to the wrench unit 12 to be consumed thereby. Therefore, when using the conventional torque wrench, a user need exert extra force to counteract the wobbling movement of the wrench head 121. Moreover, since the strain-measurement unit 13 is distal from the torque-outputting wrench head 121, measurement accuracy for torque may be low. On the other hand, force-bearing parts for transmission of forces in the conventional torque wrench are the positioning member 112 and the neck member 123. A relatively small contact surface between the positioning member 112 and the neck member 123 may cause stress concentration, which is not beneficial for transmission of forces. In addition, the positioning member 112 and the neck member 123 may easily be damaged due to stress concentration.

### SUMMARY

Therefore, an object of the disclosure is to provide an electronic torque wrench that is able to fix a wrench head at a predetermined angular position for efficient force delivery to produce accurate measurement of torque values, and that also alleviates the stress concentration problem present in the conventional torque wrench.

An electronic torque wrench according to the present disclosure includes a handle unit, a turning unit, a sensor unit, a processor unit and an operating unit.

The handle unit is formed with multiple pressing holes that are spaced apart annularly from one another around a longitudinal axis.

The turning unit includes a wrench head member, a first positioner, a second positioner and a sleeve. The wrench head member has a head portion, a strain-measurement portion that is connected to the head portion, and a shaft portion that extends from the strain-measurement portion along the longitudinal axis (L) oppositely of the head portion, and that is rotatably received in the sleeve to be in sliding contact therewith. The first and second positioners are connected to opposite ends of the shaft portion of the wrench head member and are exposed from the sleeve. The sleeve is fixed to the handle unit and is disposed between the shaft portion and the handle unit, and between the first and second positioners such that the shaft portion is prevented from moving longitudinally. The first positioner has an annular flange, a button hole, a press button and a resilient element. The annular flange projects radially from the shaft portion. The button hole is radially formed in the annular flange and is adjustable to register with a selected one of the pressing holes through a relative rotation of the shaft portion and the sleeve. The press button is slidably disposed in the button hole and is extendable into the selected one of the pressing holes. The resilient element is disposed in the button hole to bias the press button to move into the selected one of the pressing holes. The first positioner retains the wrench head at a predetermined angular position relative to the sleeve and the handle unit when the press button extends into the selected one of the pressing holes.

The sensor unit is disposed in the strain-measurement portion for measuring a deformation value of the wrench member.

The processor unit is electrically connected to the sensor unit for processing the deformation value into a torque value.

The operating unit includes a display element that is disposed on the handle unit and that is electrically connected to the processor unit for displaying the torque value.

### BRIEF DESCRIPTION OF THE DRAWINGS

Other features and advantages of the present disclosure will become apparent in the following detailed description of the embodiment with reference to the accompanying drawings, of which:

FIG. 1 is a fragmentary perspective view of a conventional torque wrench;

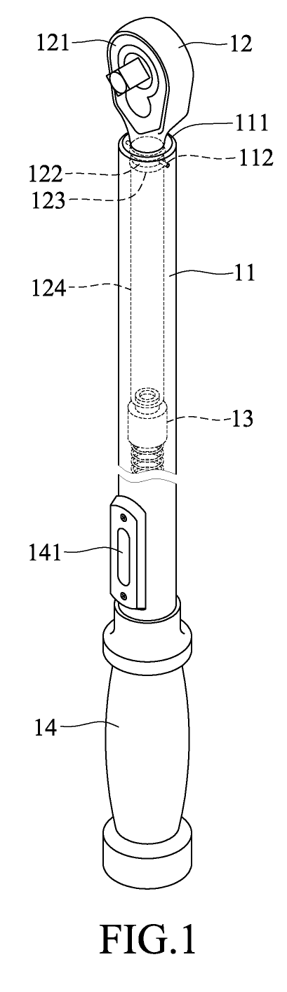

FIG. 2 is a perspective view of an exemplary embodiment of an electronic torque wrench according to the disclosure, where a head portion of a wrench head member of a turning unit of the exemplary embodiment is at an initial position;

FIG. 3 is an exploded perspective view of the exemplary embodiment;

FIG. 4 is a fragmentary, partly sectional view of the exemplary embodiment taken along line IV-IV of FIG. 2;

FIG. 5 is a sectional view of the exemplary embodiment taken along line V-V of FIG. 4, where the head portion of the wrench head member is at the initial position;

FIG. 6 is a sectional view of the exemplary embodiment taken along line VI-VI of FIG. 4, where the head portion of the wrench head member is at the initial position;

FIG. 7 is a block diagram showing an electrical connection among a sensor unit, a processor unit and an operating unit of the exemplary embodiment;

FIG. 8 is a perspective view of the exemplary embodiment, where the head portion of the wrench head member is at a clockwise rotation position;

FIG. 9 is a view similar to that of FIG. 5, where the head portion of the wrench head member is at the clockwise rotation position;

FIG. 10 is a view similar to that of FIG. 6, where the head portion of the wrench head member of the exemplary embodiment is at a counterclockwise rotation position; and

FIG. 11 is a perspective view of the exemplary embodiment, where the head portion of the wrench head member is at the counterclockwise rotation position.

### DETAILED DESCRIPTION

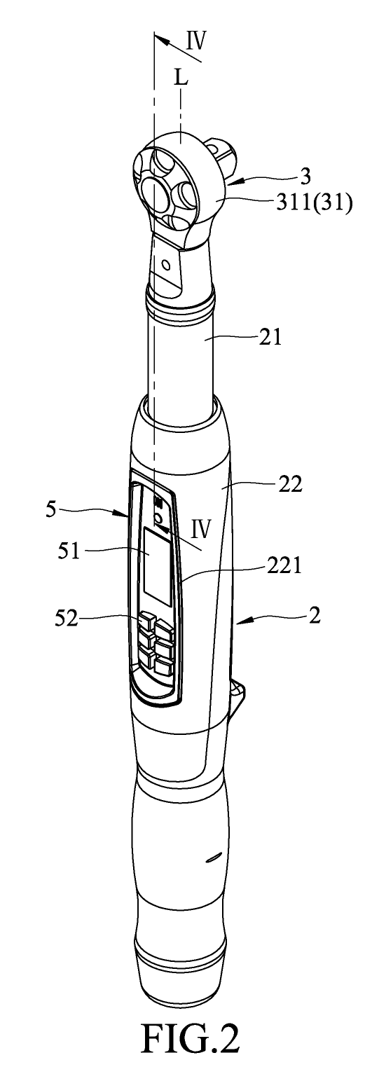

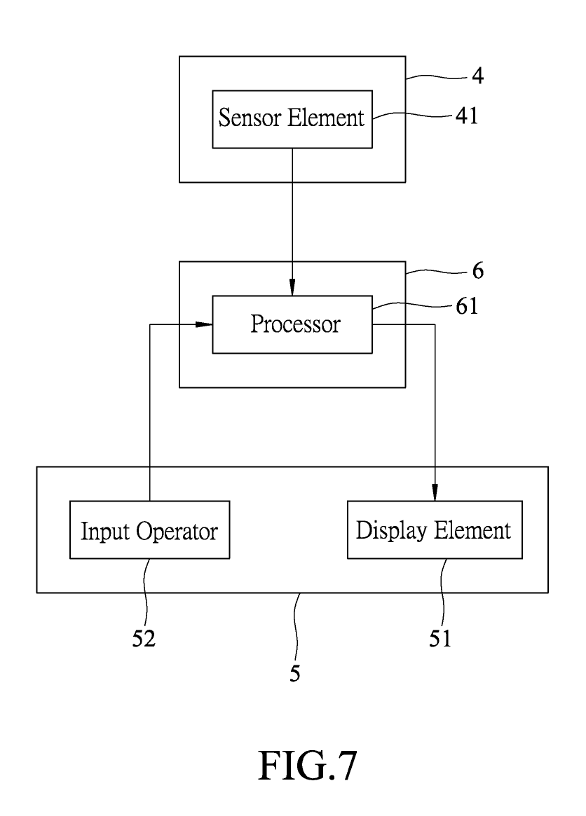

Referring to FIGS. 2, 3 and 7, an exemplary embodiment of an electronic torque wrench according to the present disclosure includes a handle unit 2, a turning unit 3, a sensor unit 4, an operating unit 5 and a processor unit 6.

The handle unit 2 has a handle tube 21, a tubular case 22 surrounding the handle tube 21 and formed with a window 221 and three pressing holes 23. The pressing holes 23 are spaced apart annularly from one another around a longitudinal axis (L) and are respectively defined as a clockwise rotation pressing hole 232, a counterclockwise rotation pressing hole 233 and an initial pressing hole 231 located between the clockwise and counterclockwise pressing holes 232, 233. The handle tube 21 is made of a metal, such as iron, with high strength and high bend resistance, and has an outside section that is exposed from the tubular case 22. The pressing holes 23 are formed in the outside section of the handle tube 21.

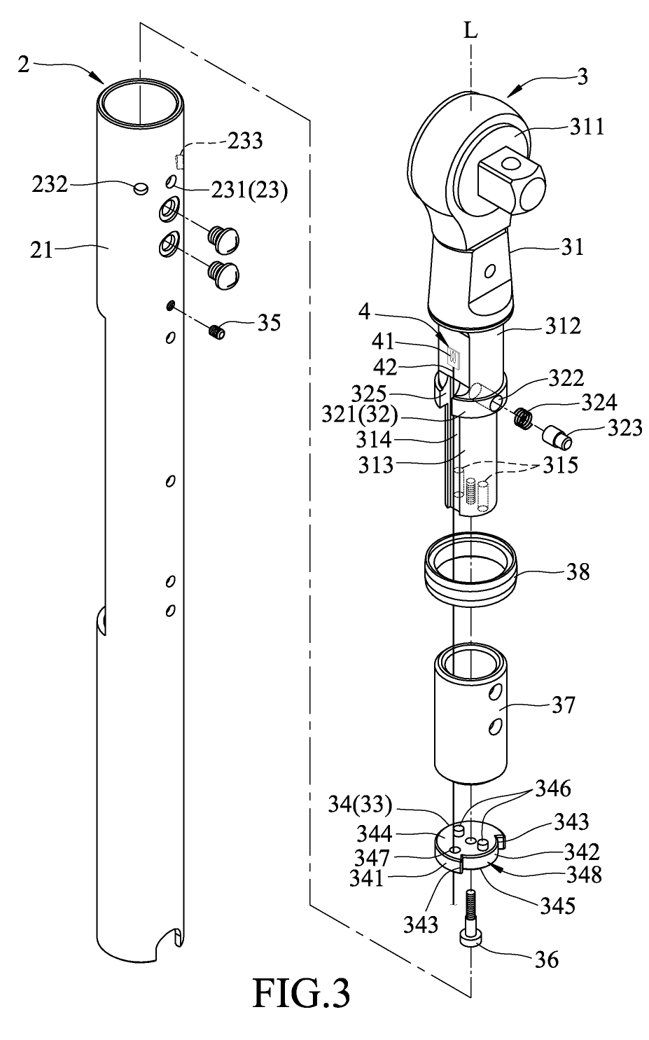

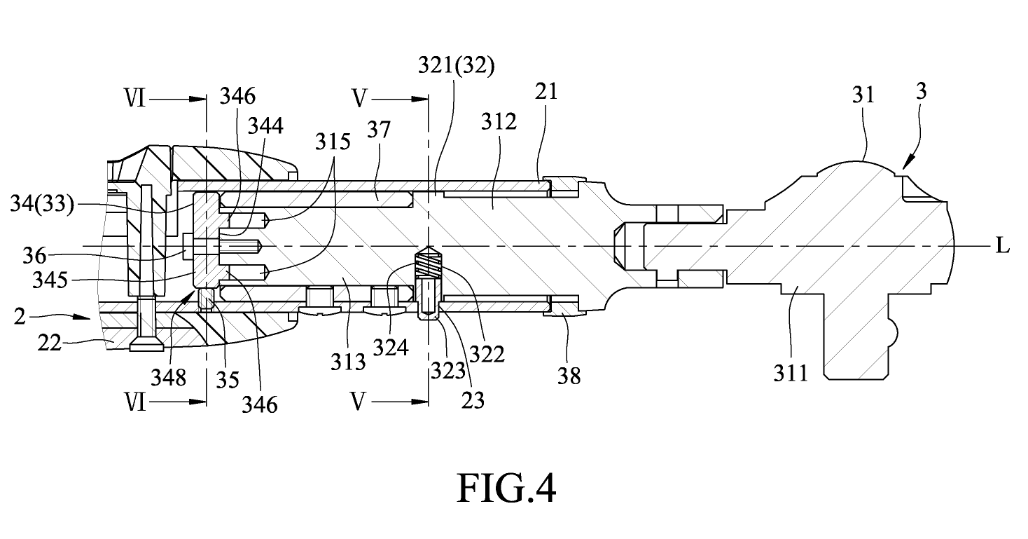

Referring to FIGS. 3 to 5, the turning unit 3 is inserted in the handle unit 2 and includes a wrench head member 31, a first positioner 32, a second positioner 33, a sleeve 37 and a dust proof ring 38.

The wrench head member 31 has a head portion 311 adapted for transferring a force exerted by a user to tighten or loosen a workpiece, a strain-measurement portion 312 connected to the head portion 311, and a shaft portion 313 extending from the stain-measurement portion 312 along the longitudinal axis (L) oppositely of the head portion 311. The shaft portion 313 is rotatably received in the sleeve 37 to be in sliding contact therewith, and is formed with a notch 314 along the longitudinal axis (L), and two insert slots 315 extending longitudinally from a free end of the shaft portion 313.

The first and second positioners 32, 33 are connected to opposite ends of the shaft portion 313 and are exposed from the sleeve 37. The handle tube 21 surrounds the sleeve 37, the strain-measurement portion 312 and the shaft portion 313.

The first positioner 32 has an annular flange 321, a button hole 322, a press button 323 and a resilient element 324. The annular flange 321 projects radially from the shaft portion 313 in proximity to the stain-measurement portion 312, and is formed with a recess 325 along the longitudinal axis (L). The button hole 322 is radially formed in the annular flange 321 and is adjustable to register with a selected one of the pressing holes 23 through a relative rotation of the shaft portion 313 and the sleeve 37. The press button 323 is slidably disposed in the button hole 322 and is extendable into the selected one of the pressing holes 23. The resilient element 324 is disposed in the button hole 322 to bias the press button 323 to move into the selected one of the pressing holes 23. In the exemplary embodiment, the resilient element 324 is a compression spring.

Referring to FIGS. 3, 4 and 6, the second positioner 33 has a disc body 34, a positioning element 35 and a fixing member 36. The disc body 34 projects radially from the shaft portion 313. The positioning element 35 is fixedly disposed on the handle tube 21. The fixing member 36 secures a center of the disc body 34 to the free end of the shaft portion 313 opposite to the annular flange 321. The disc body 34 has a large diameter circumferential surface 341, a small diameter circumferential surface 342 indented from the large diameter circumferential surface 341, two circumferentially spaced apart shoulder surfaces 343 interconnecting the large and small diameter circumferential surfaces 341, 342, a first surface 344 abutting against the free end, a second surface 345 opposite to the first surface 344, and two insert pins 346 projecting from the first surface 344 into the insert slots 315 to assist in securing the disc body 34. The disc body 34 is formed with a wire hole 347 that extends through the second surface 345 from the first surface 344 along the longitudinal axis (L). The shoulder surfaces 343 and the small diameter circumferential surface 342 cooperatively define a sliding groove 348 for the positioning element 35 to slide angularly therein. In the exemplary embodiment, the positioning element 35 is configured as a grub screw, the fixing member 36 is configured as a flat head screw, and the annular flange 321 and the wrench head member 31 are integrally formed as one piece.

The sleeve 37 is secured to the handle tube 21 of the handle unit 2 and disposed between the shaft portion 313 and the handle unit 3, and between the first and second positioners 32, 33 such that the shaft portion 313 is prevented from moving longitudinally. Therefore, the wrench head member 31 is prevented from being loosened from the sleeve 37 and the handle unit 2. The shaft portion 313 of the wrench head member 31 and the sleeve 37 has a sliding contact clearance therebetween. A clearance between the annular flange 321 of the first positioner 32 and the handle tube 21 and a clearance between the disc body 34 of the second positioner 33 and the handle tube 21 are respectively larger than the sliding contact clearance. The shaft portion 313 is limited to rotate within the sleeve 37 about the longitudinal axis (L).

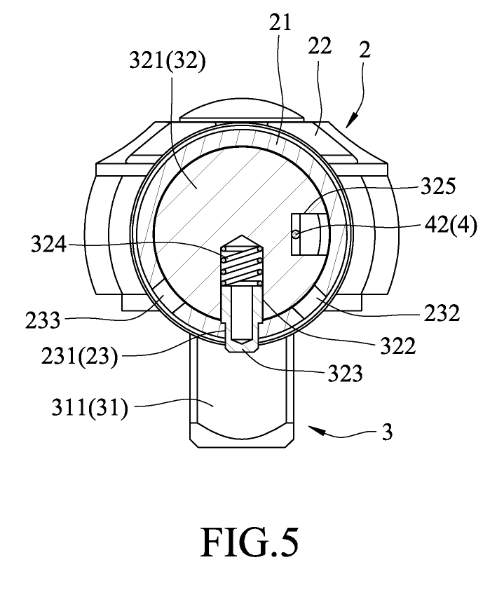

The first positioner 32 is able to retain the wrench head member 31 at a predetermined angular position relative to the sleeve 37 and the handle unit 2 when the press button 323 extends into and engages a selected one of the pressing holes 23. By engaging the press button 323 in one of the pressing holes 23, the angular position of the head portion 311 may be changed among an initial position, a clockwise rotation position and a counterclockwise rotation position. Referring back to FIG. 5, the press button 323 is biased by the resilient element 324 to move into and engage the initial pressing hole 231 so that the head portion 311 of the wrench head member 31 is fixed at the initial position.

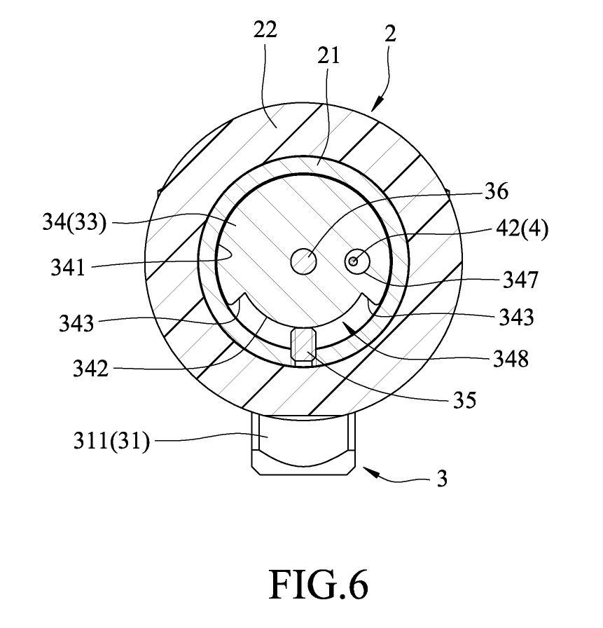

Referring back to FIG. 6, the disc body 34 of the second positioner 33 cooperates with the positioning element 35 to limit a rotation angle of the wrench head member 31 to an angle smaller than 360°. As such, an incidence of short circuit or wire breakage maybe avoided when the sensor unit 4 (see FIG. 3) is rotated along with the wrench head 31. It is worth mentioning that the pressing holes 23 are aligned with the sliding groove 348 along the longitudinal axis (L). In addition, an angular length of the sliding groove 348 for the sliding movement of the positioning element 35 substantially corresponds to an angular length of a region within which the press button 323 performs its activity. The sliding groove 348 does not affect or limit the activity of the press button 323.

Referring to FIGS. 2, 3 and 7, the sensor unit 4 has a sensor element 41 disposed in the strain-measurement portion 312 for measuring a deformation value of the wrench head member 31, and a wiring 42 connecting the sensor element 41 to the processor unit 6. In the exemplary embodiment, the sensor element 41 is a strain gauge that is disposed in proximity to the head portion 311 of the wrench head member 31 so that the deformation value can be precisely measured. After measuring the deformation value, the sensor element 41 generates a signal that is transmitted to the processor unit 6 through the wiring 42. The processor unit 6 then processes the deformation value conveyed by the signal into a torque value. The recess 325, the notch 314, and the wire hole 347 are aligned longitudinally and cooperatively form a longitudinal passage for extension of the wiring 42 therethrough. It is worth mentioning that the rotation angle of the wrench head member 31 relative to the sleeve 37 is limited to below 360° to prevent the wiring 42 from short circuiting or breaking due to excessive rotation of the wrench head member 31.

The operating unit 5 is disposed on the tubular case 22 and exposed from the window 221. The operating unit 5 includes a display element 51 that is electrically connected to the processor unit 6 for displaying the torque value, and an input operator 52 for the user to input a pre-set torque value thereinto.

The processor unit 6 includes a processor 61 that is electrically connected to the sensor unit 4 and the operating unit 5. The processor 61 processes the deformation value measured by the sensor unit 4 into the torque value and displays the torque value on the display element 51 of the operating unit 5. The pre-set torque value inputted through the input operator 52 of the operating unit 5 is monitored by the processor 61. When the torque value reaches the pre-set torque value, a warning signal is displayed on the display element 51. Measurement of the deformation value and calculation of the torque value are well-known in the art and therefore will not be further elaborated hereinafter for the sake of brevity.

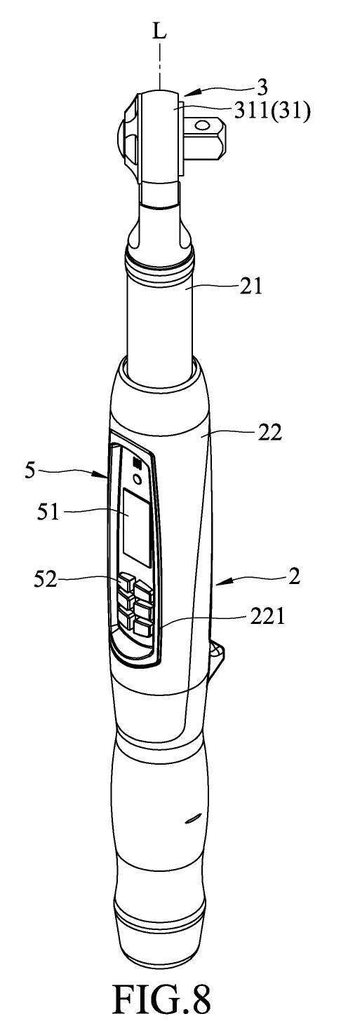

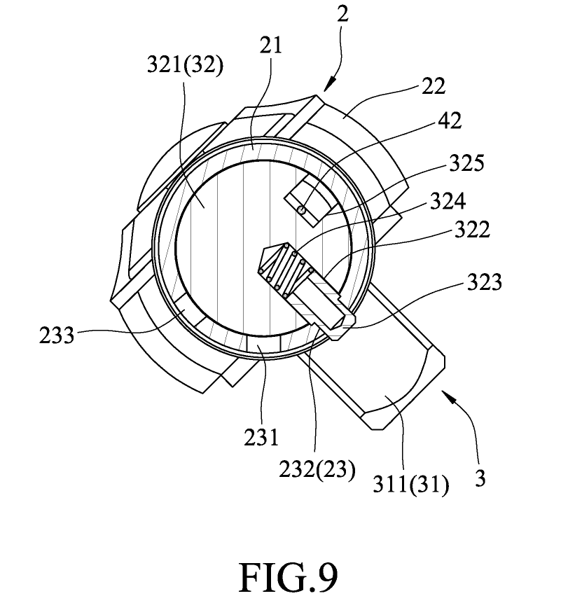

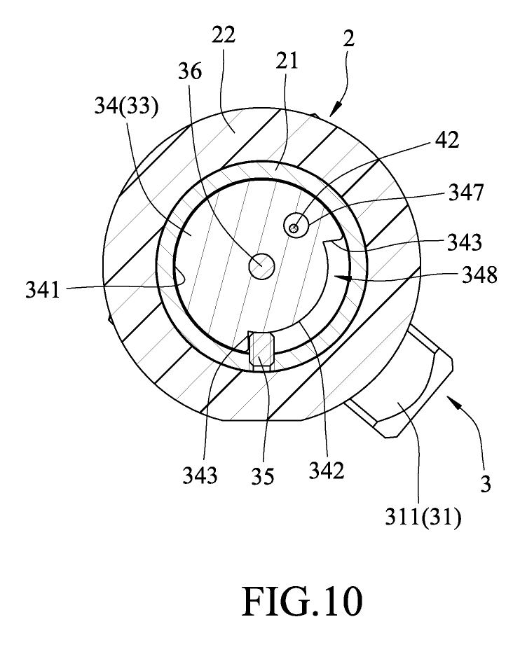

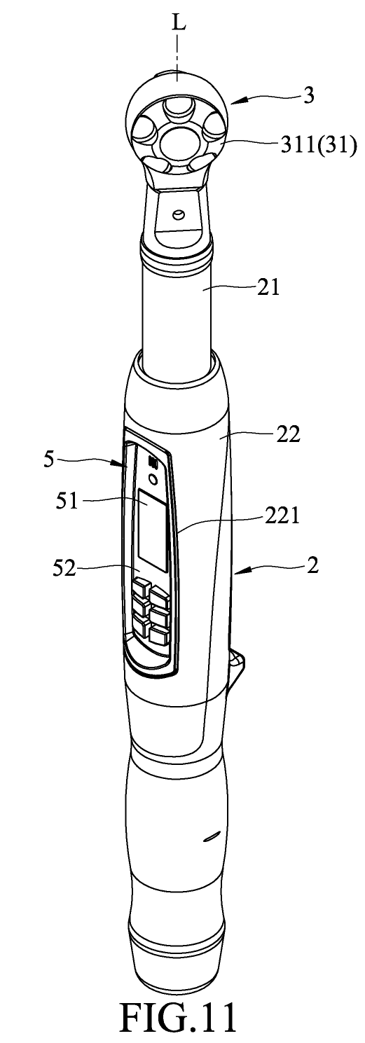

Referring to FIGS. 2, 5 and 6, normally, the press button 323 engages the initial pressing hole 231 so that the wrench head 31 is fixed at the initial position. In order to accommodate different angles at which the torque wrench of the disclosure may be operated, the press button 323 may be pressed to adjust the angular position of the wrench head member 31. Referring to FIGS. 8 to 10, the wrench head member 31 is rotated to a clockwise rotation position where the press button 323 engages the clockwise rotation pressing hole 232. Referring to FIG. 11, the wrench head member 31 is rotated to a counterclockwise rotation position where the press button 323 moves into the counterclockwise rotation pressing hole 233. It is worth mentioning that the display element 51 is always within sight of the user no matter where the head portion 311 of the wrench head member 31 is positioned.

When in use, the user may first adjust the wrench head member 31 to a desired position, and engage the wrench head member 31 with the workpiece. When the user holds a lower portion of the handle unit 2 and exerts a force to rotate the workpiece, the torque value is displayed on the display element 51 to be viewed by the user. The user may input a pre-set torque value via the input element 52 as a caution from exerting a force that would result in a torque value exceeding the pre-set torque value.

To sum up, the electronic torque wrench according to the present disclosure permits the user to adjust an angular position of the wrench head member 31 according to the application conditions of the electronic torque wrench. In the pre sent disclosure, forces are transmitted through the shaft portion 313 of the wrench head member 31 and the sleeve 37, which have a large contact surface area to disperse stress. Therefore, forces may be applied evenly to the electronic torque wrench, reducing an incidence of damage thereto. The present disclosure utilizes the second positioner 33 to limit the rotation angle of the wrench head member 31 so that the wiring 42 of the sensor unit 4 will not knot or break when the wrench head member 31 rotates. Since the sensor element 41 is proximate to the head portion 311 of the wrench head member 31, the deformation value of the wrench head member 31 can be measured precisely, and accuracy of measurement for the torque value can be increased.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An electronic torque wrench comprising:
a handle unit formed with multiple pressing holes that are spaced apart annularly from one another around a longitudinal axis (L) of the handle unit;
a turning unit including a wrench head member, a first positioner, a second positioner and a sleeve, said wrench head member having a head portion, a strain-measurement portion that is connected to said head portion, and a shaft portion that extends from said strain-measurement portion along the longitudinal axis (L) oppositely of said head portion, and that is rotatably received in said sleeve to be in sliding contact therewith, said first and second positioners being connected to opposite ends of said shaft portion of said wrench head member and being exposed from said sleeve, said sleeve being disposed between said shaft portion and said handle unit, and between said first and second positioners such that said shaft portion is prevented from moving longitudinally, said first positioner having an annular flange that projects radially from said shaft portion, a button hole that is radially formed in said annular flange and that is adjustable to register with a selected one of said pressing holes through a relative rotation of said shaft portion and said sleeve, a press button that is slidably disposed in said button hole and that is extendable into the selected one of said pressing holes, and a resilient element that is disposed in said button hole to bias said press button to move into the selected one of said pressing holes, said first positioner retaining said wrench head member at a predetermined angular position relative to said sleeve and said handle unit when said press button extends into the selected one of said pressing holes;
a sensor unit disposed in said strain-measurement portion for measuring a deformation value of said wrench head member;
a processor unit electrically connected to said sensor unit for processing the deformation value into a torque value; and
an operating unit including a display element that is disposed on said handle unit and that is electrically connected to said processor unit for displaying the torque value.

2. The electronic torque wrench as claimed in claim 1, wherein said second positioner limits a rotation angle of said wrench head member relative to said sleeve.

3. The electronic torque wrench as claimed in claim 2, wherein said second positioner has a disc body that is connected to and projects radially from said shaft portion, and a positioning element fixedly disposed on said handle unit, said disc body having a large diameter circumferential surface, a small diameter circumferential surface and two circumferentially spaced apart shoulder surfaces interconnecting said large and small diameter circumferential surfaces, said shoulder surfaces and said small diameter circumferential surface cooperatively defining a sliding groove for said positioning element to slide angularly therein.

4. The electronic torque wrench as claimed in claim 3, wherein said annular flange is connected to said shaft portion in proximity to said strain measurement portion, said disc body being connected to a free end of said shaft portion opposite of said annular flange.

5. The electronic torque wrench as claimed in claim 4, wherein said shaft portion of said head portion member is formed with at least one insert slot that extends longitudinally from said free end of said shaft portion, said disc body further having a first surface abutting against said free end, and a second surface opposite to said first surface, and at least one insert pin that projects from said first surface into said at least one insert slot.

6. The electronic torque wrench as claimed in claim 4, wherein said sensor unit has a sensor element and a wiring that connects said sensor element to said processor unit, said annular flange being formed with a recess, said shaft portion of said head portion member being formed with a notch, said disc body being formed with a wire hole, said recess, said notch and said wire hole being aligned longitudinally and cooperatively forming a longitudinal passage for extension of said wiring therethrough.

7. The electronic torque wrench as claimed in claim 3, wherein said handle unit includes a handle tube that surrounds said sleeve, said strain-measurement portion and said shaft portion, and a tubular case that surrounds said handle tube, said pressing holes being formed in said handle tube.

8. The electronic torque wrench as claimed in claim 7, wherein said tubular case is formed with a window, said operating unit being disposed on said tubular case, exposed from said window and further including an input operator for inputting a pre-set torque value.

9. The electronic torque wrench as claimed in claim 7, wherein said shaft portion of said head portion member and said sleeve has a sliding contact clearance therebetween, a clearance between said annular flange of said first positioner and said handle tube and a clearance between said disc body of said second positioner and said handle tube being larger than said sliding contact clearance.
